(19) United States
(12) Patent Application Publication
(10) Pub. No.: US 2011/0113003 A1
(43) Pub. Date: May 12, 2011

(54) MULTI-DIMENSIONAL SPECTRAL ANALYSIS FOR IMPROVED IDENTIFICATION AND CONFIRMATION OF RADIOACTIVE ISOTOPES

(75) Inventors: Ajoy K. Roy, Pasadena, CA (US); Steven A. Sunshine, Pasadena, CA (US)

(73) Assignee: Smiths Detection Inc.

(21) Appl. No.: 12/736,451

(22) PCT Filed: Mar. 27, 2009
(86) PCT No.: PCT/US2009/038505

§ 371 Date: Jan. 24, 2011

Related U.S. Application Data
(60) Provisional application No. 61/071,047, filed on Apr. 9, 2008.

(51) Int. Cl. G06N 7/02

(52) U.S. Cl. 706/52

(57) ABSTRACT

A method and system for classifies an unknown sample that contains either a first radioactive isotope, a second radioactive isotope, or a mixture of the first and second radioactive isotopes. Input vectors representative of a training set of samples for a first isotope class and a second isotope class are received. A multivariate classification model is constructed based on the received input vectors. Data is received corresponding to the unknown sample. First and second probabilities that the unknown sample respectively belongs to the first isotope class and the second isotope class are calculated. Based on the first and second probabilities, the unknown sample is classified as either the first radioactive isotope, the second radioactive isotope, or a mixture of the first and second radioactive isotopes.

This application claims benefit to U.S. provisional patent application No. 61/071,047, filed Apr. 9, 2008 to Roy et al., which is hereby incorporated by reference in its entirety.

### FIELD OF THE INVENTION

This invention is related in general to the field of sensor array detection and classification.

### BACKGROUND OF THE INVENTION

Sensor array units having sensor arrays are becoming very useful in today's society, with the threat of chemi- and bio-terrorism being more and more prominent. In more detail, chemical and biological warfare pose both physical and psychological threats to military and civilian forces, as well as to civilian populations.

There is a strong interest in radiation detection systems that are low cost, sensitive, and have a low false alarm rate. Systems that provide information about the energy of the detected radiation can allow for accurate isotope identification and better sensitivity. Commonly used isotope identification algorithms are based on matching spectral peaks with peaks from a pre-determined library. To improve identification and lower false alarms, the inventors of this application have determined that peak based search algorithms need to be augmented with full multi-dimensional spectral analysis.

### SUMMARY OF THE INVENTION

The present invention relates to a method and apparatus for sensor array detection and classification.

In accordance with one aspect of the invention, there is provided a method for classifying an unknown sample that contains either a first radioactive isotope, a second radioactive isotope, or a mixture of at least the first and second radioactive isotopes. The method includes receiving input vectors representative of a training set of samples for a first isotope class and a second isotope class. The method also includes constructing a multivariate classification model based on the received input vectors. The method further includes receiving data corresponding to the unknown sample. The method still further includes calculating first and second probabilities that the unknown sample belongs to the first isotope class and the second isotope class, respectively. The method also includes, based on the first and second probabilities, classifying the unknown sample as either the first radioactive isotope, the second radioactive isotope, or a mixture of at least the first and second radioactive isotopes.

In accordance with another aspect of the invention, there is provided an apparatus for classifying an unknown sample that contains either a first radioactive isotope, a second radioactive isotope, or a mixture of at least the first and second radioactive isotopes. The apparatus includes a vector receiving unit configured to receive input vectors representative of a training set of samples for a first isotope class and a second isotope class. The apparatus also includes a constructing unit configured to construct a multivariate classification model based on the received input vectors. The apparatus further includes a data receiving unit configured to receive data corresponding to the unknown sample. The apparatus still further includes a calculating unit configured to calculate first and second probabilities that the unknown sample belongs to the first isotope class and the second isotope class, respectively. The method also includes a classifying unit configured to classify, based on the first and second probabilities, the unknown sample as either the first radioactive isotope, the second radioactive isotope, or a mixture of at least the first and second radioactive isotopes.

In accordance with yet another aspect of the invention, there is provided a computer readable medium embodying computer program product for classifying an unknown sample that contains either a first radioactive isotope, a second radioactive isotope, or a mixture of at least the first and second radioactive isotopes, the computer program product, when executed by a computer or a microprocessor, causing the computer or the microprocessor to perform the steps of:

a) receiving input vectors representative of a training set of samples for a first isotope class and a second isotope class;

b) constructing a multivariate classification model based on the received input vectors;

c) receiving data corresponding to the unknown sample;

d) calculating first and second probabilities that the unknown sample belongs to the first isotope class and the second isotope class, respectively, and

e) based on the first and second probabilities, classifying the unknown sample as either the first radioactive isotope, the second radioactive isotope, or a mixture of at least the first and second radioactive isotopes.

It is to be understood that both the foregoing general description and the following detailed description are exemplary and explanatory only and are not restrictive of the invention as claimed.

### BRIEF DESCRIPTION OF THE DRAWINGS

The accompanying drawings, which are incorporated in and constitute a part of this specification, illustrate several embodiments of the invention and, together with the description, serve to explain the principles of the invention.

FIG. 1 shows an example of a linear SVM decision boundary that can be utilized in the present invention according to a first embodiment.

FIG. 2 shows an example of linearly non-separable data obtained from a two-dimensional feature vector.

FIG. 3 shows a three-dimensional mapping function that provides for linearly separable data, which can be used in the present invention according to the first embodiment.

FIG. 4 shows a raw energy spectrum for a 300 uCi source of 137Cs at a distance from a detector.

FIG. 5 shows the energy spectrum of FIG. 4 that has been applied to a wavelet denoising and smoothing function.

FIG. 6 shows PCA scores-based training set along with sample names, in accordance with the first embodiment of the invention.

FIG. 7 is a plot of a prediction sample along with training set samples, in accordance with the first embodiment of the invention.

FIG. 8 is a PCA-SVM plot for a training set plus a mixture sample, in accordance with the first embodiment of the invention.

FIG. 9 is a plot that shows separation and discrimination for a 2-class SVM classification model, in accordance with the first embodiment of the invention.

FIG. 10 shows an application in which the first embodiment is applied to preduct depleted uranium and highly enriched uranium samples.

FIG. 11 is a flow diagram showing a method according to the first embodiment.

FIG. 12 is a block diagram of an apparatus according to the first embodiment.

### DETAILED DESCRIPTION

Reference will now be made in detail to embodiments of the invention, examples of which are illustrated in the accompanying drawings. An effort has been made to use the same reference numbers throughout the drawings to refer to the same or like parts.

Unless explicitly stated otherwise, “and” can mean “or,” and “or” can mean “and.” For example, if a feature is described as having A, B, or C, the feature can have A, B, and C, or any combination of A, B. and C. Similarly, if a feature is described as having A, B, and C, the feature can have only one or two of A, B, or C.

Unless explicitly stated otherwise, “a” and “an” can mean “one or more than one.” For example, if a device is described as having a feature X, the device may have one or more of feature X.

The present invention is directed to a system and method for building multivariate predictive classification/pattern recognition models with input spectral data as predictors and using such models to predict an unknown sample. For example, a two class model will identify whether an unknown sample is one of two isotopes. The input spectral data can be the full energy spectrum or regions of spectrum suitable for discrimination and correct identifications of isotopes included in a classification model. A support vector machine (SVM), which is a well known classification technique, is used to develop multivariate classification models in a preferred implementation of a first embodiment of the present invention. Other classification techniques including neural networks, decision tree, boosted decision tree, linear discriminant analysis, Bayesian networks, can also alternatively be used in other embodiments of the present invention. The present invention is illustrated below with a description of a support vector machine technique and application of that technique for isotope identification.

A description of a support vector machine utilized in the first embodiment of the present invention is provided hereinbelow. Support vector machines map input vectors to a higher dimensional space where a maximally separating hyper plane is constructed for separation of classes of interest. Support vector machines are described, for example, in Corrina Cortes and V. Vapnik, “Support-Vector Networks”, Machine Learning, 20, 1995.

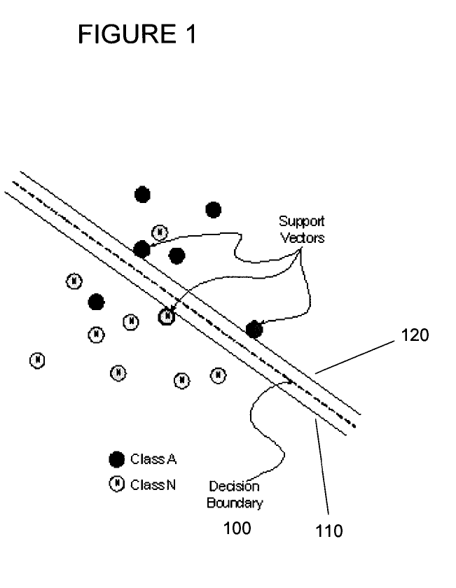

FIG. 1 shows example of a Linear SVM Decision Boundary, whereby training set samples for classes A and N are shown in that figure. For isotope identification, the two classes can be 235U and 137Cs, and the training set samples are represented by input vectors which are intensities/counts at energies of interest. From the training set samples, a SVM classification model is constructed, which then classifies and predicts an unknown sample with its input vector. To develop a linear SVM classifier, two parallel hyper planes 110, 120 are constructed on each side of the hyper plane 100 that separates the data. The separating hyper plane 100 is the hyper plane that maximizes the distance between the two parallel hyper planes 110, 120. An assumption is made that the larger the margin or distance between these parallel hyper planes 110, 120, the better the generalization error of the classifier will be. Making the SVM model results in choosing support vectors from the training set samples as shown in FIG. 1.

Once the support vectors are chosen, the model output Y for a vector X is calculated as below:

Y(X)=Σαᵢyᵢ<h(X),h(xᵢ)>+β;K(X,xᵢ)=<h(X),h(xᵢ)>=Kernel function,

where αᵢ=weight (support) for each support vector (observation) i, β=offset parameter (also known as “bias” in machine learning), yᵢ=1 for class A, −1 for class N. In general, if Y is greater than 0, the sample belongs to class A, otherwise the sample belongs to class N.

The support vector machine methodology utilized in the first embodiment has the following properties:

a) SVM draws decision boundaries which maximize the margin between classes.

b) SVM can represent complex non-linear functions.

c) Efficient training algorithms exist for SVM.

d) Regularization allows for non-separable data sets.

e) Classification only requires dot product (or kernel product) of sample with support vectors.

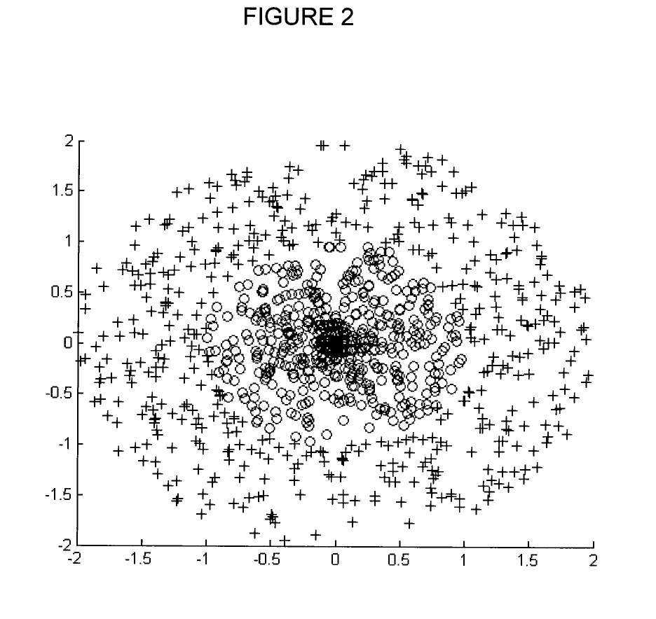

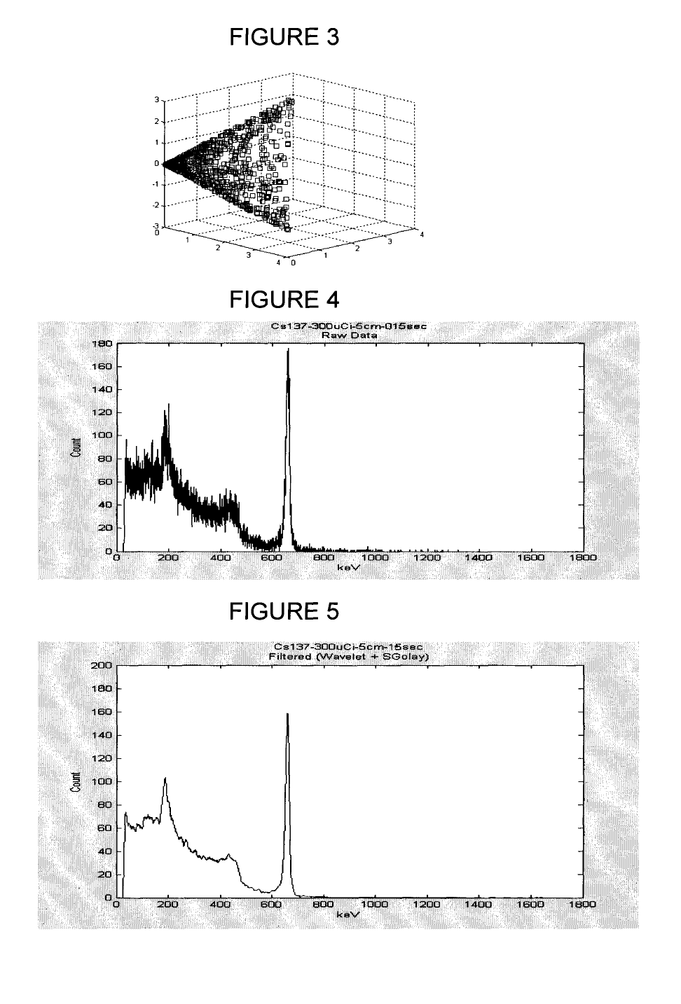

Mapping to a higher dimensional feature space can make data linearly separable, as illustrated in FIGS. 2 and 3. Kernel functions make such mapping relatively inexpensive. FIG. 2 shows an example of linearly non-separable data, whereby feature vector v=[x y]^{T} is two-dimensional. FIG. 3 shows a three-dimensional (3-D) mapping function f(v)=[x²y² ₂1/2*x*y], whereby the Kernel function K(v,z)=f(v)^{T}f(z). Mapping the feature vector v into a 3D space such as shown in FIG. 3 makes the data linearly separable, effectively creating a non-linear boundary. The first embodiment preferably utilizes a 3D mapping.

A Gaussian kernel function (also known as Radial Basis Function) is used for SVM modeling in a preferred embodiment of the present invention. The Gaussian kernel function is represented as:

K(v,z)=exp(−(v−z)²/c).

For a two class classifier, the Y(X) output is calculated for each of the two models in which one or the other class is the target class. The result is that a two element Y output vector is obtained:

Y=[Y_{A} Y_{B}];

The present invention according to the first embodiment then proceeds to calculate probabilities for the sample to belong to each of the classes, as provided below:

P_{A}=exp(Y_{A})/(exp(Y_{A})+exp(Y_{B}));

P_{B}=exp(Y_{B})/(exp(Y_{A})+exp(Y_{B}));

P_{A}+P_{B}=1;

If P_{A} or P_{B}=>0.8, it is determined that the sample is a unique isotope belonging to the class with probability >0.8.
If 0.3<P_{A}=<0.7 or 0.3<P_{B}=<0.7, the sample is determined to be a mixture of A and B.
If P_{A} or P_{B} lies between 0.7 and 0.8, it is determined that the sample is either a unique isotope or a mixture of two isotopes.

The above example that provides values 0.8, 0.3 and 0.7 for use in identifying a sample are illustrative only, and other values may be utilized while remaining within the spirit and scope of the invention. The actual determination of those values can be obtained via experimental tests performed beforehand on a set (e.g., 10, 50, 100) of known samples.

SVM classification, identification and confirmation of a single isotope sample according to the first embodiment will now be described in detail hereinbelow. FIG. 4 shows a raw energy spectrum for a 300 μCi source of ¹³⁷Cs at 5 cm from a radiation detector. The data collection time was 15 secs.

Application of wavelet denoising and Savitzky-Golay smoothing results in the spectrum shown in FIG. 5. As shown in the spectrum of FIG. 5, the ¹³⁷Cs spectra often contain a peak in the Compton region that is in the same region as an actual peak for ²³⁵U (˜185 kEv). Application of a conventional Peak Search/ID Algorithm on the ¹³⁷Cs sample as shown in the previous figures results in the isotope assignments shown below:

| Sample | Isotope ID |
|---|---|
| Cs 137_300 uCi_5 cm_015 sec | 137 Cs 235 U |

The uranium identification is due to a peak in the Compton region of the cesium spectrum. The present invention according to the first embodiment applies a two class ¹³⁷Cs /²³⁵U SVM classification model to determine, in the case of a mixed isotope identification of Cs and U, whether the spectrum is representative of one or two isotopes present.

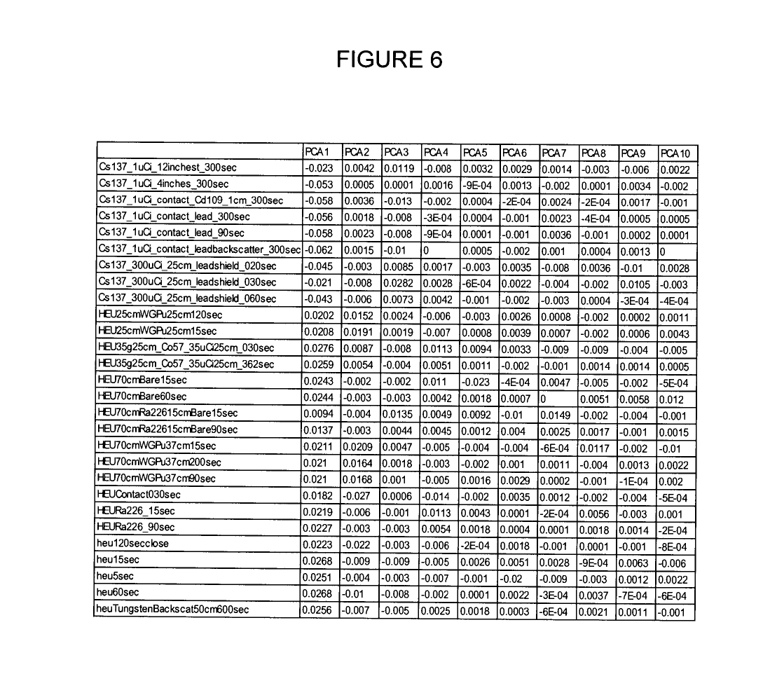

The two information rich regions 170-215 kEv and 640-684 kEv of the energy spectrum are used for multivariate SVM analysis in the first embodiment. The input to the SVM classification model are PCA (Principal Component Analysis) scores calculated for the first ten principal components (whereby other numbers other than 10, such as 5 or 20, may be utilized while remaining within the spirit and scope of the present invention). The input to the SVM classification model may correspond to the input vector X as described above. The inputs to the PCA model are intensities for the selected channels in the two regions of the energy spectrum. Selected channel intensities, or the entire energy spectrum, can also be input to the SVM model, in alternative implementations of the first embodiment. Use of PCA scores helps avoid over-fitting especially when the number of samples in each class is small. Various variable selection techniques including genetic algorithm (GA) can be used for selection of important channels. The PCA scores based training set along with sample names as obtained by way of the first embodiment is shown in FIG. 6.

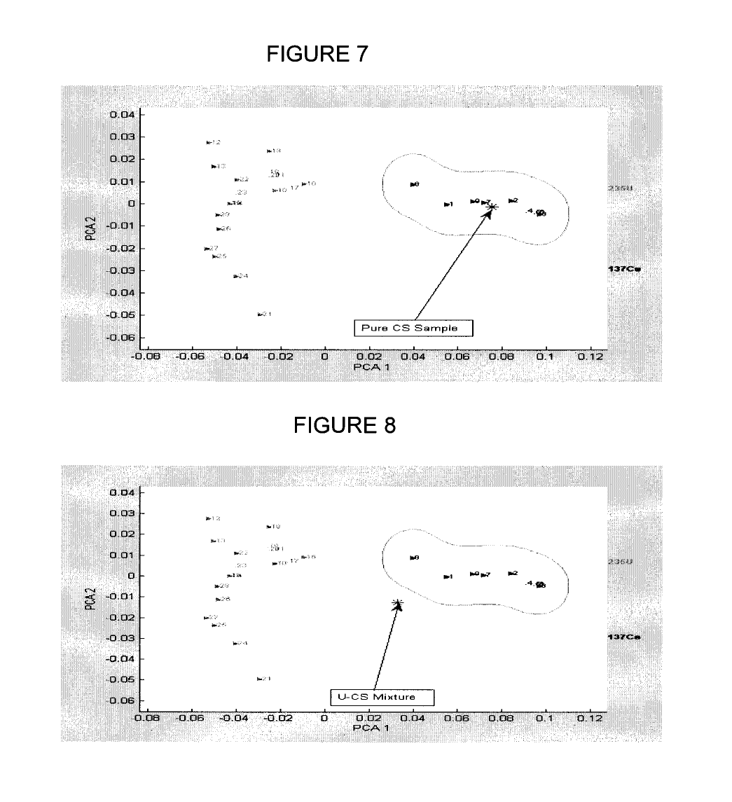

FIG. 7 shows a plot of a prediction sample (for the same Cs spectrum shown in FIG. 5) along with the training set samples, as obtained by way of the first embodiment. The training samples represent spectral data from cesium and uranium samples under a wide variety of conditions. The first two principal components are shown for visualization purposes. The decision contours are also shown in FIG. 7.

The analysis performed according to the first embodiment also allows for calculation of a probability. The present invention according to the first embodiment is capable of evaluating probabilities as a function of synthetic mixtures of uranium and cesium, and can determine that a probability >0.8 is a clear indication of a pure Cs sample. For a current sample, if the probability of the spectra being that of pure cesium is determined to be 0.85, then the first embodiment automatically concludes that the sample is a pure Cs sample.

To confirm that the present invention according to the first embodiment would correctly identify a mixture of Cs and U, the probability associated with a synthetic spectrum that represents 40% ¹³⁷Cs and 60% ²³⁵U was calculated. The PCA-SVM plot for the training set plus the mixture sample is shown in FIG. 8. In this case, the probability(_{137cs})=0.42, and as such the first embodiment correctly concluded that the sample is a mixture of cesium and uranium. In addition to the SVM model described above, a number of other SVM models can be used in the present invention according to the first embodiment, in cases where empirical data suggests a likely misclassification issue.

The training set and prediction set samples used to validate the present invention are shown below in Table 1.

TABLE 1

Training Set
DU 37 kg 25 cm 015 sec
DU 37 kg 25 cm 030 sec
DU 37 kg 25 cm 067 sec
DU 37 kg 25 cm 300 sec
DU 37 kg Stacked 25 cm 301 sec
DU 37 kg Stacked 25 cm 30 sec
HEU 25 cm WGPu 25 cm 120 sec
HEU 25 cm WGPu 25 cm 15 sec
HEU 35 g 25 cm_Co 57_35 uCi 25 cm_030 sec
HEU 35 g 25 cm_Co 57_35 uCi 25 cm_362 sec
HEU 70 cm Bare 15 sec
HEU 70 cm Bare 60 sec
HEU 70 cm Ra 22615 cm Bare 15 sec
HEU 70 cm WGPu 37 cm 15 sec
HEU 70 cm WGPu 37 cm 200 sec
HEU 70 cm WGPu 37 cm 90 sec
HEU Contact 030 sec
HEU Graphite 15 cm 60 sec
HEU Ra 226_15 sec
HEU Ra 226_90 sec
HEU Steel 1 cm 120 sec
HEU Steel 1 cm 15 sec
HEU Steel 1 cm 30 sec
HEU Steel 2 cm 120 sec
heu 120 sec close
heu 5 sec
heu 60 sec
heu Tungsten Backscat 50 cm 600 sec
Prediction Set
DU 37 kg Stacked 25 cm 120 sec
HEU 70 cm Ra 22615 cm Bare 90 sec
heu 15 sec

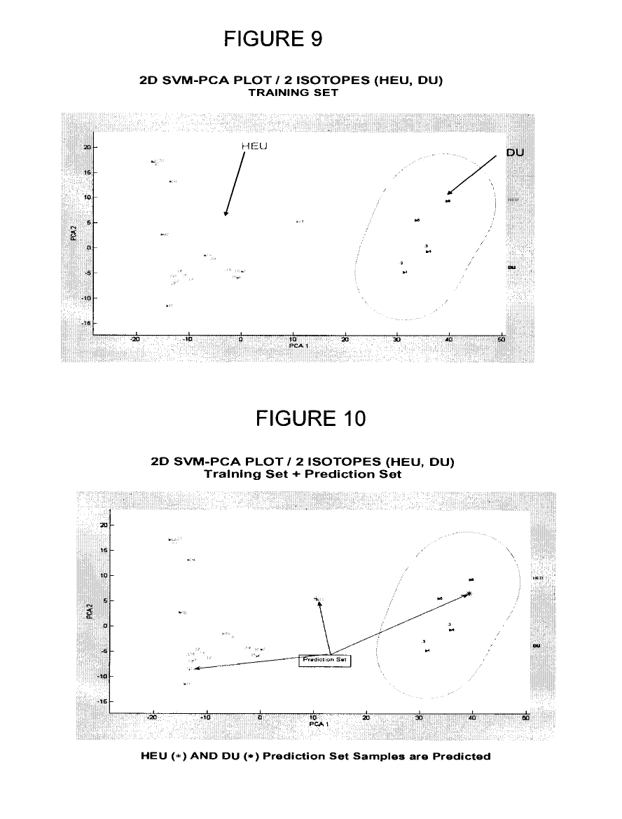

FIG. 9 is a plot that shows separation and discrimination for the 2-class SVM classification model, in accordance with the first embodiment. FIG. 10 shows successful application of the first embodiment to predict depleted uranium (DU) and highly enriched uranium (HEU) samples. The correct prediction of HEU/DU prediction samples is indicated by locations of the prediction samples in the respective HEU and DU domains in the PCA-SVM plot.

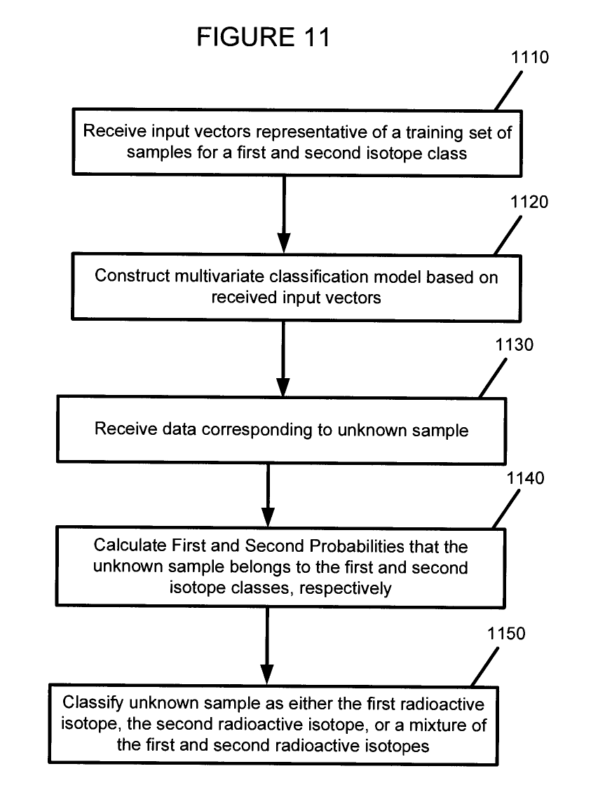

FIG. 11 is a flow diagram of a method for classifying an unknown sample that contains either a first radioactive isotope, a second radioactive isotope, or a mixture of the first and second radioactive isotopes, according to the first embodiment. In a first step 1110, input vectors representative of a training set of samples for a first isotope class and a second isotope class are received. In a second step 1120, a multivariate classification model is constructed based on the received input vectors. In a third step 1130, data corresponding to the unknown sample is received. In a fourth step 1140, first and second probabilities that the unknown sample respectively belongs to the first isotope class and the second isotope class are calculated. In a fifth step 1150, based on the first and second probabilities, the unknown sample is classified as either the first radioactive isotope, the second radioactive isotope, or a mixture of the first and second radioactive isotopes according to the first embodiment.

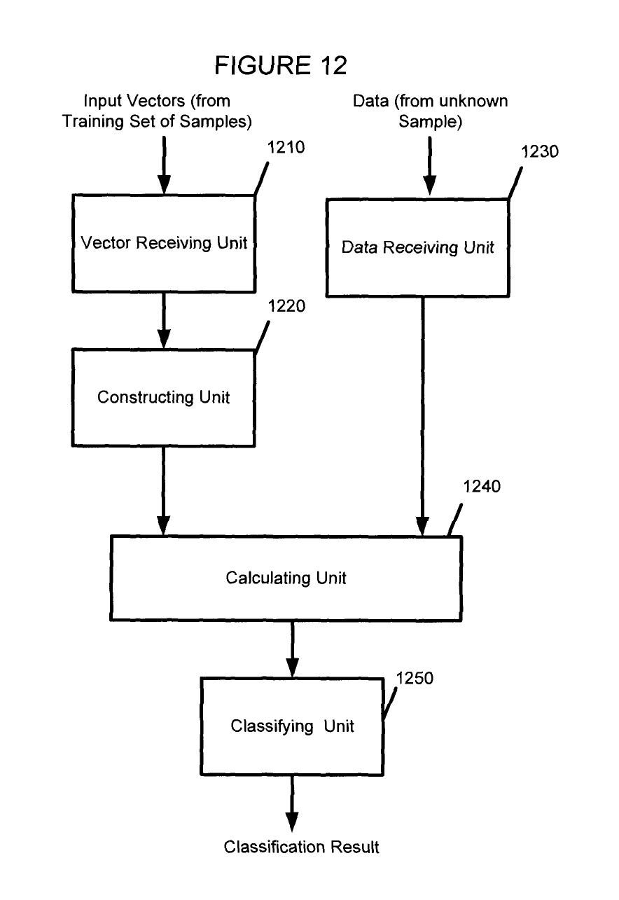

FIG. 12 is a block diagram showing one possible implementation of an apparatus according to the first embodiment. A vector receiving unit 1210 receives input vectors representative of a training set of samples for a first isotope class and a second isotope class. A constructing unit 1220 constructs a multivariate classification model based on the received input vectors provide by the vector receiving unit 1210. A data receiving unit 1230 receives data corresponding to the unknown sample. A calculating unit 1240 calculates first and second probabilities that the unknown sample belongs to the first isotope class and the second isotope class, respectively, based on outputs from the data receiving unit 1230 and the constructing unit 1220. A classifying unit 1250 classifies, based on the first and second probabilities provided by the calculating unit 1240, the unknown sample as either the first radioactive isotope, the second radioactive isotope, or a mixture of the first and second radioactive isotopes.

The embodiments described above have been set forth herein for the purpose of illustration. This description, however, should not be deemed to be a limitation on the scope of the invention. Various modifications, adaptations, and alternatives may occur to one skilled in the art without departing from the claimed inventive concept. For example, while the present invention has been described with respect to an unknown sample that may be either a first radioactive isotope, a second radioactive isotope, or a mixture of those two radioactive isotopes, the present invention can also be utilized to distinguish whether an unknown sample is a first radioactive isotope (e.g., Cesium 137 or Uranium 238) or whether the unknown sample is background (e.g., contains no radioactive isotope), using the same method and apparatus as discussed above with respect to the first embodiment. Also, the present invention can be used to detect whether an unknown sample contains one or more radioactive isotopes from a set of different radioactive isotopes numbering three or greater (e.g., Plutonium, Uranium, or Cesium, or any combination thereof). The spirit and scope of the invention are indicated by the following claims.

What is claimed is:

1. A method for classifying an unknown sample that contains either a first radioactive isotope, a second radioactive isotope, or a mixture of at least the first and second radioactive isotopes, comprising:
a) receiving input vectors representative of a training set of samples for a first isotope class and a second isotope class;
b) constructing a multivariate classification model based on the received input vectors;
c) receiving data corresponding to the unknown sample;
d) calculating first and second probabilities that the unknown sample belongs to the first isotope class and the second isotope class, respectively, and
e) based on the first and second probabilities, classifying the unknown sample as either the first radioactive isotope, the second radioactive isotope, or a mixture of at least the first and second radioactive isotopes.

2. The method according to claim 1, wherein the first radioactive isotope corresponds to Uranium 235, and wherein the second radioactive isotope corresponds to Cesium 137.

3. The method according to claim 1, wherein the data received in step c) corresponds to spectral intensities at a first frequency range of interest and at a second frequency range of interest.

4. The method according to claim 1, wherein the input vector is at least a two-dimensional vector.

5. The method according to claim 1, wherein the multivariate classification model is constructed by using a kernel function.

6. The method according to claim 1, wherein the first and second probabilities added together equal 1,
wherein when either the first probability or the second probability is greater than a first predetermined value, the unknown sample is respectively classified as the first radioactive isotope or the second radioactive isotope,
wherein when the first probability is greater than a second predetermined value and less than a third predetermined value, or when the second probability is greater than the second predetermined value and less than the third predetermined value, the unknown sample is classified as a mixture of at least the first and second radioactive isotopes, and
wherein when either the first probability or the second probability is a value greater than the third predetermined value but less than the first predetermined value, the unknown sample is classified as being either a mixture of at least the first and second radioactive isotopes or a unique isotope corresponding to a respective one of the first and second radioactive isotopes,
wherein the first predetermined value is greater than the third predetermined value and the third predetermined value is greater than the second predetermined value.

7. A computer readable medium storing a computer program, which, when executed on a computer or a microprocessor, is used to classify an unknown sample that contains either or both of a first radioactive isotope and a second radioactive isotope, the computer program when executed on the computer or the microprocessor performing the steps of:
a) receiving input vectors representative of a training set of samples for a first isotope class and a second isotope class;
b) constructing a multivariate classification model based on the received input vectors;
c) receiving data corresponding to the unknown sample;
d) calculating first and second probabilities that the unknown sample belongs to the first isotope class and the second isotope class, respectively, and
e) based on the first and second probabilities, classifying the unknown sample as either the first radioactive isotope, the second radioactive isotope, or a mixture of at least the first and second radioactive isotopes.

8. The computer readable medium according to claim 7, wherein the first radioactive isotope corresponds to Uranium 235, and wherein the second radioactive isotope corresponds to Cesium 137.

9. The computer readable medium according to claim 7, wherein the data received in step c) corresponds to spectral intensities at a first frequency range of interest and at a second frequency range of interest.

10. The computer readable medium according to claim 7, wherein the input vector is at least a two-dimensional vector.

11. The computer readable medium according to claim 7, wherein the multivariate classification model is constructed by using a kernel function.

12. The computer readable medium according to claim 7, wherein the first and second probabilities added together equal 1,
wherein when either the first probability or the second probability is greater than a first predetermined value, the unknown sample is respectively classified as the first radioactive isotope or the second radioactive isotope,
wherein when the first probability is greater than a second predetermined value and less than a third predetermined value, or when the second probability is greater than the second predetermined value and less than the third predetermined value, the unknown sample is classified as a mixture of at least the first and second radioactive isotopes, and
wherein when either the first probability or the second probability is a value greater than the third predetermined value but less than the first predetermined value, the unknown sample is classified as being either a mixture of at least the first and second radioactive isotopes or a unique isotope corresponding to a respective one of the first and second radioactive isotopes,
wherein the first predetermined value is greater than the third predetermined value and the third predetermined value is greater than the second predetermined value.

13. An apparatus for classifying an unknown sample that contains either a first radioactive isotope, a second radioactive isotope, or a mixture of at least the first and second radioactive isotopes, comprising:
a vector receiving unit configured to receive input vectors representative of a training set of samples for a first isotope class and a second isotope class;
a constructing unit configured to construct a multivariate classification model based on the received input vectors;
a data receiving unit configured to receive data corresponding to the unknown sample;
a calculating unit configured to calculate first and second probabilities that the unknown sample belongs to the first isotope class and the second isotope class, respectively, and
a classifying unit configured to classify, based on the first and second probabilities, the unknown sample as either the first radioactive isotope, the second radioactive isotope, or a mixture of at least the first and second radioactive isotopes.

14. The apparatus according to claim 13, wherein the first radioactive isotope corresponds to Uranium 235, and wherein the second radioactive isotope corresponds to Cesium 137.

15. The apparatus according to claim 13, wherein the data received by the data receiving unit corresponds to spectral intensities at a first frequency range of interest and at a second frequency range of interest.

16. The apparatus according to claim 13, wherein the input vector is at least a two-dimensional vector.

17. The apparatus according to claim 13, wherein the constructing unit constructs the multivariate classification model by using a kernel function.

18. The apparatus according to claim 13, wherein the first and second probabilities added together equal 1,
wherein when either the first probability or the second probability is greater than a first predetermined value, the unknown sample is respectively classified as the first radioactive isotope or the second radioactive isotope,
wherein when the first probability is greater than a second predetermined value and less than a third predetermined value, or when the second probability is greater than the second predetermined value and less than the third predetermined value, the unknown sample is classified as a mixture of at least the first and second radioactive isotopes, and
wherein when either the first probability or the second probability is a value greater than the third predetermined value but less than the first predetermined value, the unknown sample is classified as being either a mixture of at least the first and second radioactive isotopes or a unique isotope corresponding to a respective one of the first and second radioactive isotopes,
wherein the first predetermined value is greater than the third predetermined value and the third predetermined value is greater than the second predetermined value.

19. A method for classifying an unknown sample that contains either a radioactive isotope or background, comprising:
a) receiving input vectors representative of a training set of samples for a first isotope class corresponding to the radioactive isotope, and receiving input vectors representative of a training set of samples for a background sample that does not contain any radioactive isotope;
b) constructing a multivariate classification model based on the received input vectors;
c) receiving data corresponding to the unknown sample;
d) calculating first and second probabilities that the unknown sample belongs to the first isotope class and to the background, respectively, and
e) based on the first and second probabilities, classifying the unknown sample as either the first radioactive isotope or background.

20. The method according to claim 19, wherein the first radioactive isotope corresponds to Uranium 235, and wherein the second radioactive isotope corresponds to Cesium 137.

21. The method according to claim 19, wherein the data received in step c) corresponds to spectral intensities at a first frequency range of interest and at a second frequency range of interest.

22. The method according to claim 19, wherein the input vector is at least a two-dimensional vector.

23. The method according to claim 19, wherein the multivariate classification model is constructed by using a kernel function.

24. The method according to claim 19, wherein the first and second probabilities added together equal 1,
wherein when either the first probability or the second probability is greater than a first predetermined value, the unknown sample is respectively classified as the first radioactive isotope or the second radioactive isotope,
wherein when the first probability is greater than a second predetermined value and less than a third predetermined value, or when the second probability is greater than the second predetermined value and less than the third predetermined value, the unknown sample is classified as a mixture of at least the first and second radioactive isotopes, and
wherein when either the first probability or the second probability is a value greater than the third predetermined value but less than the first predetermined value, the unknown sample is classified as being either a mixture of at least the first and second radioactive isotopes or a unique isotope corresponding to a respective one of the first and second radioactive isotopes,
wherein the first predetermined value is greater than the third predetermined value and the third predetermined value is greater than the second predetermined value.
